(19) United States
(12) Patent Application Publication
(10) Pub. No.: US 2005/0010832 A1
(43) Pub. Date: Jan. 13, 2005

(54) Method and apparatus of reducing scan power in the process of unloading and restoring processor content by scan chain partition and disable

(75) Inventors: Amanda C. Caswell, Austin, TX (US); Tung Nguyen Pham, Cedar Park, TX (US); Timothy J. Rubidoux, Pflugerville, TX (US)

Correspondence Address: Gregory W. Carr;670 Founders Square, 900 Jackson Street, Dallas, TX, 75202, US

(73) Assignee: International Business Machines Corporation, Armonk, NY (US)

(21) Appl. No.: 10/616,846

(22) Filed: Jul. 10, 2003

(51) Int. Cl. G06F 1/26

(52) U.S. Cl. 713/330

(57) ABSTRACT

A method and an apparatus are provided for reducing scan power consumption when unloading and restoring content of a processor. The processor has one or more scan chains. First, at least one scan chain is partitioned into a plurality of segments. Second, one of the segments is scanned at a time.

### BACKGROUND OF THE INVENTION

1. Field of the Invention

The invention relates generally to a computer system and, more particularly, to saving power consumption in a scan process of the computer system.

2. Description of the Related Art

The issue of steady power dissipation has been an interesting topic for all integrated circuit designers. To resolve this issue, many sophisticated methods, such as clock-gating and sleep-mode implementations, were introduced.

A more advanced static power management technique involves storing a whole system in an off-chip device and turning off the power supply to the whole chip. The main idea is that, once software detects a long period of no activity in the processor, it will issue a shutdown command to a built-in power management circuitry to freeze all the functional clocks, unload the content of the whole processor (i.e., content of all latches in the processor), store it into an off-chip, non-volatile memory device, and then shut off the power supply to the chip and wait for the wake-up command from the peripheral device (e.g., a wake-up signal). Once the wake-up signal is detected, this power management circuitry scans in (i.e., restores) the saved state of the chip previously stored in the off-chip non-volatile memory device and resumes clocking.

The process of scanning out the content of the chip can be done through the scan structure of the chip. The content being scanned out is written into the off-chip memory via a unique set of pins that can provide the sufficient clocking, data stream, and required controls for the particular type of storage device being used. In a prior art configuration, all the scan chains are serially linked into a master chain. This configuration requires enough clocking pulses to scan out (as well as scan in) all bits in the chain.

In another prior art configuration, each scan chain is scanned individually. To scan data out this way, the controller needs to provide enough clocking to scan out all bits in each chain separately. Under these prior art configurations, however, the process of scanning out the whole chip can be costly in terms of the power used in the scan out and scan in.

Therefore, a need exists for reducing scan power in the process of unloading and restoring a chip's content.

### SUMMARY OF THE INVENTION

The present invention provides a method and an apparatus for reducing scan power consumption when unloading and restoring content of a processor. The processor has one or more scan chains. First, at least one scan chain is partitioned into a plurality of segments. Second, one of the segments is scanned at a time.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 depicts a block diagram illustrating scan circuitry; and

FIG. 2 depicts a schematic diagram illustrating a partitioned scan chain of FIG. 1.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise.

In the remainder of this description, a processing unit (PU) may be a sole processor of computations in a device. In such a situation, the PU is typically referred to as an MPU (main processing unit). The processing unit may also be one of many processing units that share the computational load according to some methodology or algorithm developed for a given computational device. For the remainder of this description, all references to processors shall use the term MPU whether the MPU is the sole computational element in the device or whether the MPU is sharing the computational element with other MPUs, unless indicated otherwise.

The present invention provides a more energy-efficient way to send data out by dividing each scan chain into equal length segments, with the last segment to be the offset, and scanning each smaller segment one at a time. The offset is used to handle the variation in length between each chain. To scan data out this way, the controller needs to provide enough clocking to scan out all bits in each segment of the scan chain and keep track of the length, the order of the divided segments, and offset of each chain.

In the following discussion, the approach of the present invention is compared to those of the aforementioned prior art configurations to illustrate the advantage of the present invention in terms of power consumption. If the total number of bits to be scanned out is “n”, the total number of bits being written into an off-chip memory is the same. However, the control protocol to initiate the write/read sequence will add some overhead to the whole process and this overhead varies between types of scan structures. The overhead is in terms of the total number of cycles needed to initiate the write/read sequence to memory, read scan chain length information being stored in the memory module (assuming that scan chain information is being stored this way), and write cycle time. Based on the complexity of each type of controller, the magnitude of the overhead would be larger in the present invention than in the aforementioned prior art configurations.

This difference is not large and is overwhelmed by the amount of power being saved by the scan scheme improvement. Considering only the scan power under the assumption that all bits would switch as the scan progresses, then in the worst case, power consumption for storing and retrieving the chip's content is much less in the present invention than in the prior art configurations.

In the case of the first prior art configuration, where all the scan chains are serially linked into a master chain, the power consumption for storing and retrieving, in the worst case, is approximately 2*(1+n)*(n/2) or (1+n)*n switches, assuming that each bit in the chain will switch (worst case).

In the case of the second prior art configuration, where each chain is scanned individually, the power consumption for storing and retrieving, in the worst case, is approximately 2*((1+n)/m)*(n/2/m)*m or (1+n)*n/m switches, assuming that each bit in the chain will switch (worst case) and the scan structure has m chains.

In the case of the present invention, the power consumption for storing and retrieving, in the worst case, is approximately 2*((1+n)/m/p)*(n/2/m/p)*m*p or (1+n)*n/(m*p) witches, assuming that each bit in the chain will switch (worst case), the scan structure has m chains, and each chain is divided into p segments.

Comparing the three equations above, the present invention consumes much less power than the first and second prior art configurations. The power being saved is based on how many segments each scan chain in the design is partitioned into. The partitioning of the scan chain, however, requires more space. The multiplexing circuitry used to enable and inhibit the scan process to each partitioned segment will grow as the partitioning factor “p”, increases. This increases the chip size and power consumption as well. However, the power used by the multiplexing circuit is very small compared to the amount of power saved by partitioning the scan chains. It is the designer's choice to balance the power saved and the area being used.

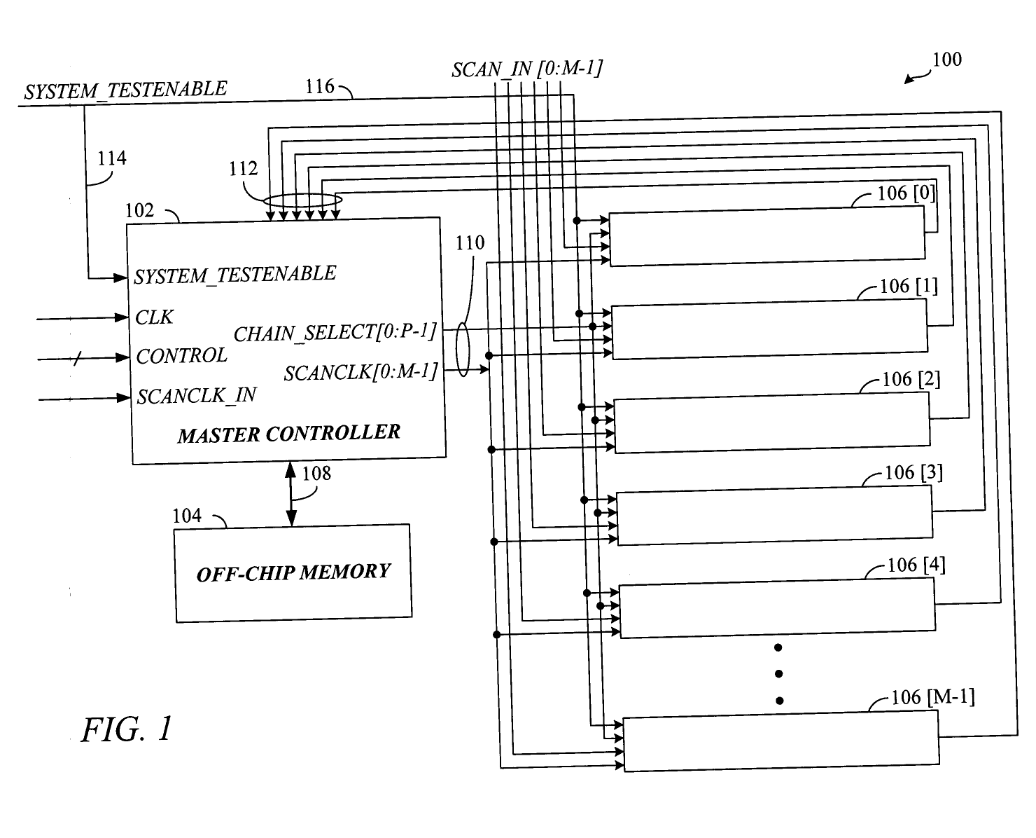

Referring to FIG. 1 of the drawings, the reference numeral 100 generally designates a block diagram 100 illustrating scan circuitry. The scan circuitry 100 comprises a master controller 102, an off-chip memory 104, and one or more scan chains 106[0:M−1], where M is an integer equal to or greater than 1. In the following discussion, the scan chain 106[i] refers to any one of the scan chain(s) 106[0:M−1], where i=0, . . . , M−1.

The master controller 102 receives various input signals including SYSTEM_TESTENABLE, CLK, CONTROL, and SCANCLK_IN. With these input signals, the master controller 102 generates CHAIN_SELECT and SCANCLK signals. The master controller 102 is coupled to the off-chip memory 104 via a connection 108. The master controller 102 is also coupled to the scan chain 106[i] via a connection 110 to provide the scan chain 106[i] with the CHAIN_SELECT and SCANCLK signals. The master controller 102 is also coupled to the scan chain 106[i] via a connection 112 to receive SCAN_OUT signal(s). Both the master controller 102 and the scan chain 106[i] receive SYSTEM_TESTENABLE via connections 114 and 116. The scan chain 106[i] further receives a SCAN_IN signal.

The master control 102, which is in charge of the whole data store and retrieval process, has control of the scan clock SCANCLK[0:m−1], assuming that the chip has m scan chains. Each scan clock signal of the SCANCLK bus controls the corresponding scan clock of that scan chain. If the signal SYSTEM_TESTENABLE is active, then SCANCLK[0:m−1] was sourced directly from SCANCLK_IN to enable test functions to proceed as normal. If the SYSTEM_TESTENABLE signal is inactive and CONTROL signals are in the state that enables the data storing process, then SCANCLK[0:m−1] are controlled by the master controller 102 to operate at a desired speed at which the system is set up to operate. SCANCLK[0:m−1] are active one at a time to enable one chain in the design to be unloaded at a time.

The master controller 102 has control of the CHAIN_SELECT signal, which selects the particular subsection of the chain to be scanned. Each chain is divided into p segments, where the last segment might be the offset (e.g., shorter than the rest). There are m SCAN_IN signals SCAN_IN[0:m−1] feeding into the chip. The SCAN_IN ports of the scan chains are for test purposes only.

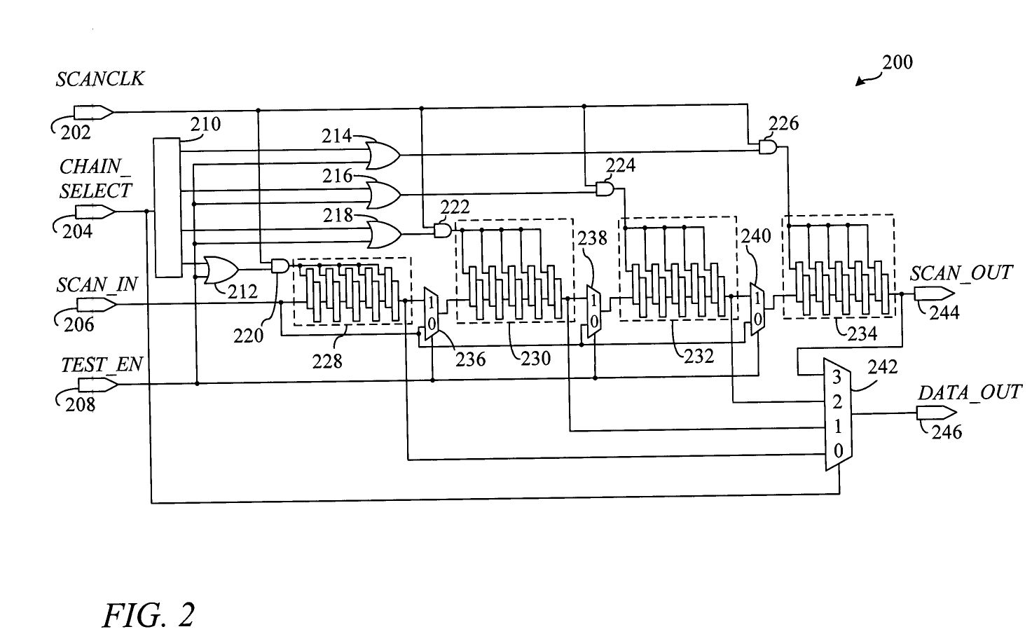

Now referring to FIG. 2, a schematic diagram 200 illustrates a partitioned scan chain 106 of FIG. 1. The partitioned scan chain 200 comprises a SCANCLK port 202, a CHAIN_SELECT port 204, a SCAN_IN port 206, a TEST_EN port 208, a decoder 210, a first OR gate 212, a second OR gate 214, a third OR gate 216, a fourth OR gate 218, a first AND gate 220, a second AND gate 222, a third AND gate 224, a fourth AND gate 226, a first segment 228, a second segment 230, a third segment 232, a fourth segment 234, a first multiplexer 236, a second multiplexer 238, a third multiplexer 240, a fourth multiplexer 242, a SCAN_OUT port 244, and a DATA_OUT port 246.

Note that the scan chain 200 is partitioned into the segments 228, 230, 232, and 234. Each segment is shown to have four master-slave latches connected in series. The number of segments in the scan chain and the number of latches in each segment may vary depending on the particular implementation without departing from the spirit of the present invention.

The SCANCLK port 202, CHAIN_SELECT port 204, SCAN_IN port 206, and TEST_EN port 208 are configured to receive corresponding input values, as shown in FIG. 1. The decoder 210 is coupled to the CHAIN_SELECT port 204. The first OR gate 212, second OR gate 214, third OR gate 216, and fourth OR gate 218 each are coupled to both the decoder 210 and the TEST_EN port 208 to receive their inputs. The first AND gate 220, second AND gate 222, third AND gate 224, and fourth AND gate 226 are coupled to the outputs of the first OR gate 212, second OR gate 214, third OR gate 216, and fourth OR gate 218, respectively, to receive their respective inputs. The first AND gate 220, second AND gate 222, third AND gate 224, and fourth AND gate 226 are also coupled to the SCANCLK port 202 to receive their inputs.

The first segment 228, second segment 230, third segment 232, and fourth segment 234 are coupled to the output of the first AND gate 220, second AND gate 222, third AND gate 224, and fourth AND gate 226, respectively, to receive their clock inputs. The first segment 228 is also coupled to the SCAN_IN port 206 to receive its scan input. The first multiplexer 236 is coupled to both the output of the first segment 228 and the SCAN_IN port 206 for receiving its two inputs. The second segment 230 is coupled to the output of the first multiplexer 236 to receive its scan input.

Similarly, the second multiplexer 238 is coupled to both the output of the second segment 230 and the SCAN_IN port 206 for receiving its two inputs. The third segment 232 is coupled to the output of the second multiplexer 238 to receive its scan input. Likewise, the third multiplexer 240 is coupled to both the output of the third segment 232 and the SCAN_IN port 206 for receiving its two inputs. The fourth segment 234 is coupled to the output of the third multiplexer 240 to receive its scan input.

The fourth multiplexer 242 is coupled to the outputs of the first segment 228, second segment 230, third segment 232, and fourth segment 234 to receive its four inputs. Note that the number of inputs of the fourth multiplexer 242 depends on the number of segments in the scan chain 200. The fourth multiplexer 242 is also coupled to the CHAIN_SELECT port 204 to receive its control signal. The SCAN_OUT port 244 is coupled to the output of the fourth segment 234. The DATA_OUT port 246 is coupled to the output of the fourth multiplexer 242.

In the operation of the scan chain 200, The SCANCLK port 202 provides overall scan clock to the rest of the chip. The CHAIN_SELECT port 204 determines which section of the partitioned chain is being scanned. The SCAN_IN port 206 is the master “scan in” port for scan test purposes as well as the data retrieval port. The TEST_EN port 208 is the master test switch to put the chip either in functional mode or in test mode. The decoder 210 is for interpreting the CHAIN_SELECT signal sent in and enabling/inhibiting the appropriate section of the partitioned scan chain 200.

The AND gates 220, 222, 224, and 226 each function as a SCANCLK inhibitor and follow the output of the decoder 210 to enable/inhibit SCANCLK to the first section of each latch of the respective segment 228, 230, 232, and 234. The multiplexers 236, 238, and 240 each function as a SCAN_OUT selector to select either the SCAN_OUT of the last latch in the previous partitioned section for scan test purposes or values from the SCAN_IN port for data retrieval to a subsequent segment for data retrieval purposes.

The SCAN_OUT port 244 is the primary scan-out port for test purposes. This port serves as the primary data-out observation point. The fourth multiplexer 242 functions as a data-out master multiplexer. The fourth multiplexer 242 selects one of the four outputs from the segments 228, 230, 232, and 234, according to the CHAIN_SELECT value. Preferably, this selection is done when the whole system is in the data storing state. The DATA_OUT port 246 serves as the primary data unloading point when data is stored into an off-chip module (e.g., the off-chip memory 104 of FIG. 1).

Each segment is scanned via a unique SCANCLK. All of these SCANCLK nets are derived from the SCANCLK port 202 and are originally provided from the master controller 102 of FIG. 1. These SCANCLK nets are gated off by the decoder 210 via the AND gates 220, 222, 224, and 226. The decoder 210 is controlled by the CHAIN_SELECT input to the chain 200, which is also being controlled by the master controller 102 of FIG. 1.

At the start of the segments 230, 232, and 234, the SCAN_IN port to the first latch is multiplexed by the multiplexers 236, 238, and 240, respectively, so that the respective multiplexers each either scans the SCAN_IN port into the first latch or the output of the last latch of the previous segment. The selection is done via the TEST_EN port 208. If the chip is in test mode, the TEST_EN signal is active. in this case, the multiplexers 236, 238, and 240 will select the SCAN_IN port fed into the corresponding first latch of the segments 230, 232, and 234, respectively.

The SCAN_OUT port 244 is coupled to the last latch of the segment 234 for test scan purposes. However, the last latch output of every segment is coupled to the input of the fourth multiplexer 242, which is controlled by the CHAIN_SELECT port 204 to selectively output the scan-out value of the currently active segment. The output of the fourth multiplexer 242 is fed to the DATA_OUT port 246. The output from the DATA_OUT port 246 is fed back into the master controller 102 to send data out to the off-chip memory 104, as shown in FIG. 1.

At any given time while the TEST_EN port 208 is inactive, one segment is enabled to scan at a time. The other segments remain inactive, as their scan clocks are inhibited. After finishing scanning out for one segment, the master controller 102 of FIG. 1 can move over to the next segment by asserting the next CHAIN_SELECT value, which in turn enables the corresponding segment's SCAN_IN value to be connected to the SCAN_IN port 206 for data retrieval. In the meantime, the other segments remain unchanged. This process repeats until all segments are scanned.

It will be understood from the foregoing description that various modifications and changes may be made in the preferred embodiment of the present invention without departing from its true spirit. This description is intended for purposes of illustration only and should not be construed in a limiting sense. The scope of this invention should be limited only by the language of the following claims.

1. A method for reducing scan power consumption when unloading and restoring content of a processor having one or more scan chains, the method comprising the steps of:
partitioning at least one scan chain into a plurality of segments; and
scanning one of the plurality of segments at a time.

2. The method of claim 1, wherein the plurality of segments comprises one or more segments of a predetermined length and an offset segment.

3. The method of claim 2, wherein the offset segment is used to handle variations in length between the one or more scan chains.

4. The method of claim 1, wherein the step of scanning one of the plurality of segments at a time comprises the steps of:
providing enough clocking to scan all bits in the one of the plurality of segments; and
keeping track of the predetermined length, an order of the segments, and the offset segment.

5. The method of claim 1, further comprising the step of scanning any remaining one or more of the plurality of segments one at a time to complete scanning the at least one scan chain.

6. The method of claim 1, further comprising the steps of:
partitioning any remaining one or more of the one or more scan chains into a plurality of segments; and
scanning the plurality of segments one at a time.

7. An apparatus for reducing scan power consumption when unloading and restoring content of a processor having one or more scan chains, the apparatus comprising:
means for partitioning at least one scan chain into a plurality of segments; and
means for scanning one of the plurality of segments at a time.

8. The apparatus of claim 7, wherein the plurality of segments comprises one or more segments of a predetermined length and an offset segment.

9. The apparatus of claim 8, wherein the offset segment is used to handle variations in length between the one or more scan chains.

10. The apparatus of claim 7, wherein the means for scanning one of the plurality of segments at a time comprises:
means for providing enough clocking to scan all bits in the one of the plurality of segments; and
means for keeping track of the predetermined length, an order of the segments, and the offset segment.

11. The apparatus of claim 7, further comprising means for scanning any remaining one or more of the plurality of segments one at a time to complete scanning the at least one scan chain.

12. The apparatus of claim 7, further comprising:
partitioning any remaining one or more of the one or more scan chains into a plurality of segments; and
scanning the plurality of segments one at a time.

13. A computer program product for reducing scan power consumption when unloading and restoring content of a processor having one or more scan chains, the computer program product having a medium with a computer program embodied thereon, the computer program comprising:
computer program code for partitioning at least one scan chain into a plurality of segments; and
computer program code for scanning one of the plurality of segments at a time.

14. The computer program product of claim 13, wherein the plurality of segments comprises one or more segments of a predetermined length and an offset segment.

15. The computer program product of claim 14, wherein the offset segment is used to handle variations in length between the one or more scan chains.

16. The computer program product of claim 13, wherein the computer program code for scanning one of the plurality of segments at a time comprises:
computer program code for providing enough clocking to scan all bits in the one of the plurality of segments; and
computer program code for keeping track of the predetermined length, an order of the segments, and the offset segment.

17. The computer program product of claim 13, the computer program further comprising computer program code for scanning any remaining one or more of the plurality of segments one at a time to complete scanning the at least one scan chain.

18. The computer program product of claim 13, the computer program further comprising:
computer program code for partitioning any remaining one or more of the one or more scan chains into a plurality of segments; and
computer program code for scanning the plurality of segments one at a time.

19. Scan circuitry for reducing scan power consumption when unloading and restoring content of a processor having one or more scan chains, the scan circuitry comprising:
a scan structure comprising one or more scan chains, wherein at least one of the one or more scan chain is partitioned into a plurality of segments; and
a master controller coupled to the scan structure for scanning one of the plurality of segments at a time.

20. The scan circuitry of claim 19, further comprising an off-chip memory coupled to the master controller for storing unloaded content of the processor.
